(19) United States
(12) Patent Application Publication
(10) Pub. No.: US 2025/0127684 A1
(43) Pub. Date: Apr. 24, 2025

(54) APPARATUS AND METHOD FOR HOLDING A VIAL

(71) Applicants: Peter L. DORNHOFER, Clovis, CA (US); Brent A. WILSON, Fresno, CA (US); Myles T. DORNHOFER, Carlsbad, CA (US)

(72) Inventors: Peter L. DORNHOFER, Clovis, CA (US); Brent A. WILSON, Fresno, CA (US); Myles T. DORNHOFER, Carlsbad, CA (US)

(21) Appl. No.: 18/885,735

(22) Filed: Sep. 15, 2024

Related U.S. Application Data
(60) Provisional application No. 63/545,033, filed on Oct. 20, 2023.

(51) Int. Cl. A61J 1/16

(52) U.S. Cl. CPC A61J 1/16

(57) ABSTRACT

The invention provides an apparatus and method for holding vials and other containers for use in medical and other applications wherein hands-free access to vials and other containers is desired. The apparatus includes a clamp-like vial receiving portion having a pair of opposing jaws, including a first jaw having a pair of planar surfaces arranged at an angle, and a second jaw having a pair of opposing curved surfaces each in the form of a portion of a conical frustum with the curved surfaces being arranged at an angle. The planar and curved surfaces of the opposing jaws cooperate to stably hold vials and other containers of various circumference sizes.

### CROSS-REFERENCE TO RELATED APPLICATIONS

This application claims the benefit of provisional application No. 63/545,033, filed Oct. 20, 2023, the entire contents of which are incorporated herein by reference for all purposes.

### FIELD OF THE INVENTION

The invention is directed to apparatuses for medical procedures. More particularly, the invention is directed to an apparatus and method for providing hands-free access to a vial during a medical procedure. The invention also finds use in other applications where hands-free access to a vial or other small container is desired, such as in laboratory applications.

### BACKGROUND

Medical procedures routinely require the application of an injectable agent that is aspirated from a flip-top vial by a syringe. Currently, this activity often employs two individuals wherein the individual performing the injecting aspirates the agent from a vial that is held by another individual, who may be in a sterile environment such as a surgical suite or during a sterile procedure.

This practice introduces risks to medical staff and patients. For instance, the individual holding the vial can be subjected to needlesticks as vials are typically very small such that the hand holding the vial is very close to the vial's injectable seal. This can expose the individual holding the vial to bloodborne viral and bacterial pathogens, such as MRSA, hepatitis and HIV. The practice also exposes the patient to the risk of infection as the sterile field can be contaminated by the individual holding the vial.

The practice of manually holding a vial for aspiration is also inefficient as it employs two medical staff. Thus, the individual holding the vial is prevented from performing other tasks. Moreover, additional staff must be present to perform a routine medical procedure.

What is needed in the art therefore is a hands-free apparatus and method for permitting a single individual to safely and efficiently aspirate an injectable agent from a vial.

### SUMMARY OF THE INVENTION

The invention provides a hands-free apparatus and method for holding a vial that permits a single individual to safely and efficiently aspirate an agent from a vial for administration to a patient.

The invention avoids exposing medical staff to accidental needlesticks during the aspiration of agents from a vial. The invention also reduces the risk of contamination of the sterile field as a second individual is not required for the aspiration of an injectable agent from a vial.

The apparatus of the invention is adapted to hold a variety of vial sizes and other containers having a circular cross-section, such as ampules and test tubes. Thus, the apparatus and method of the invention can be used in other settings where such containers need to be secured, such as in laboratory applications.

### BRIEF DESCRIPTION OF THE DRAWINGS

FIG. 1 shows a perspective view of an embodiment of the inventive apparatus holding a vial.

FIG. 2 shows a perspective view of an alternate embodiment of the inventive apparatus holding a vial.

FIG. 3 shows a front perspective view of the vial receiving portion of the apparatus of FIG. 1.

FIG. 4 shows a front perspective view of the vial receiving portion of the apparatus of FIG. 2.

FIG. 5 shows a rear perspective view of the vial receiving portion of the apparatus of FIG. 2.

FIG. 6 shows an exploded of view the vial receiving portion of the apparatus of FIG. 1.

FIG. 7 shows an exploded view of the vial receiving portion of the apparatus of FIG. 2.

FIG. 8 shows a front view of the forward end of the first vial engaging member.

FIG. 9 shows a front view of the forward end of the second vial engaging member.

FIG. 10 shows a side view of the second vial engaging member.

The figures referred to above are not necessarily drawn to scale and should be understood to present a representation of the invention, illustrative of the principles involved. Some features of the inventive apparatus depicted in the drawings may have been enlarged or distorted relative to others to facilitate explanation and understanding. The same reference numbers are used in the drawings for similar or identical components and features shown in various alternative embodiments. The inventive apparatus, as disclosed herein, can have configurations and components determined, in part, by the intended application and environment in which it is used.

### DETAILED DESCRIPTION

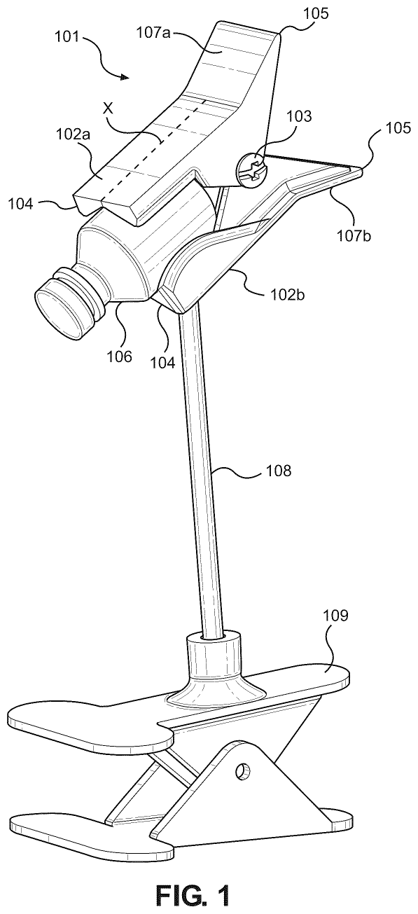

FIG. 1 shows a perspective view of an embodiment of the inventive apparatus comprising vial receiving portion 101 having first vial engaging member 102a rotatably coupled to second vial engaging member 102b by hinge 103. First vial engaging member 102a and second vial engaging member 102b oppose one another and form forward end 104 and rear end 105 of vial receiving portion 101. FIG. 1 shows vial receiving portion 101 holding vial 106 in forward end 104 of vial receiving portion 101. First vial engaging member 102a and second vial engaging member 102b form ear 107a and ear 107b on rear end 105 of vial receiving portion 101. Ears 107a and 107b are adapted to be pressed towards one another by a user to compress spring 110 within vial receiving portion 101 to cause first vial engaging member 102a and second vial engaging member 102b to rotate about hinge 103 such that first vial engaging member 102a and second vial engaging member 102b separate from one another on forward end 104 to place vial receiving portion 101 in an open configuration for receiving a vial.

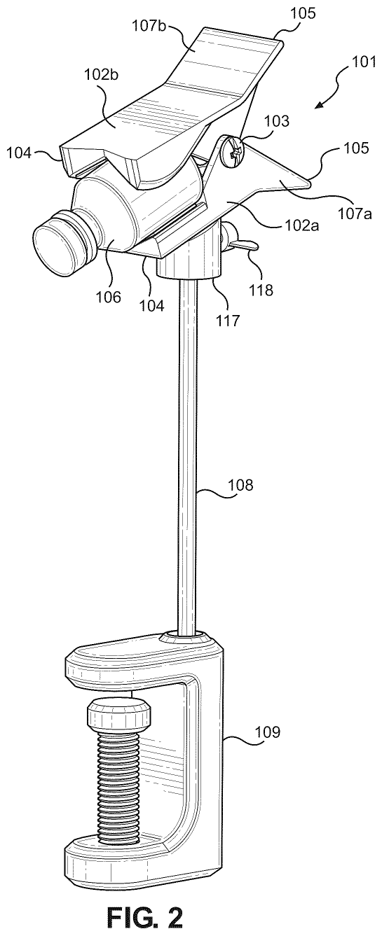

In the embodiment shown in FIG. 1, vial receiving portion 101 is coupled to the upper end of stand 108 by the outer surface of vial engaging member 102b, while the bottom end of stand 108 is coupled to stand securing portion 109. Stand securing portion 109 is adapted to be secured to a surface, such as a medical tray, surgical stand, or counter, for example. Stand securing portion 109 can be, for example, a spring-loaded clamp (as shown), or a c-clamp (as shown in FIG. 2) or a weighted body having sufficient weight to permit a medical professional to pierce the injectable seal of vial 106 with a needle to aspirate an agent from the vial.

FIG. 2 shows an alternate embodiment of the inventive apparatus wherein vial receiving portion 101 is coupled to the upper end of stand 108 by the outer surface of vial engaging member 102a. As with the embodiment depicted in FIG. 1, vial receiving portion 101 can be secured to the upper end of stand 108 by securing portion 117 which can be molded as a portion of the outward facing surface of the vial engaging member. Securing portion 117 can comprise a first aperture for receiving the upper end of stand 108 and a second aperture for receiving tension screw 118 which is adapted to thread into the second aperture and contact the upper end of stand 108 to secure the upper end of the stand within the first aperture of securing portion 117.

In some embodiments, the apparatus omits stand securing portion 109 such that the bottom end of stand 108 nests within an aperture on the surface to which the apparatus is to be secured. The aperture can assume a similar design as securing portion 117 and tension screw 118 to permit the bottom end of stand 108 to be secured to a surface in a similar fashion as securing portion 117. As depicted in FIGS. 1 and 2, vial receiving portion 101 can be coupled to the upper end of stand 108 such that forward end 104 is biased towards the bottom end of stand 108. Forward end 104 can be biased towards the bottom of stand 108 at an angle of up to about 45 degrees, up to about 30 degrees, or up to about 15 degrees, said angles being determined with respect to a horizontal plane that is perpendicular to the longitudinal axis of stand 108. As used in this disclosure, the term “about” means the quantity, value or amount that is referenced, or that varies, plus or minus, by up to 20%. In some embodiments, securing portion 117 is substituted with a tension screw on the bottom surface of vial engaging member 102b (or vial engaging member 102a) such that vial receiving portion 101 is rotatably coupled to stand 108 to permit the bias of vial receiving portion 101 to be adjusted.

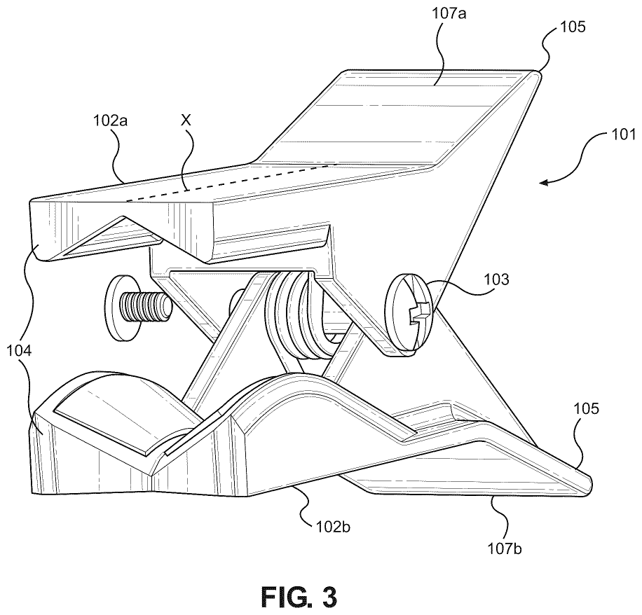

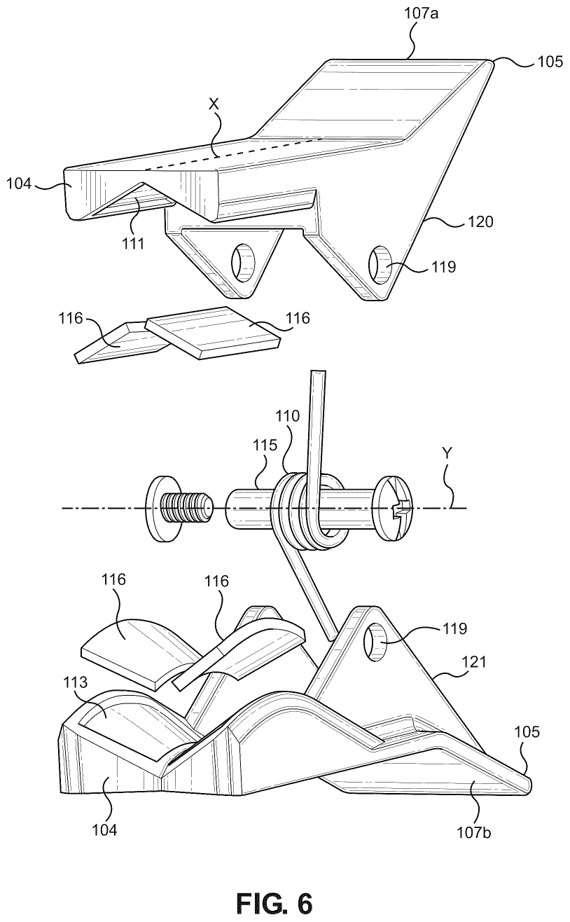

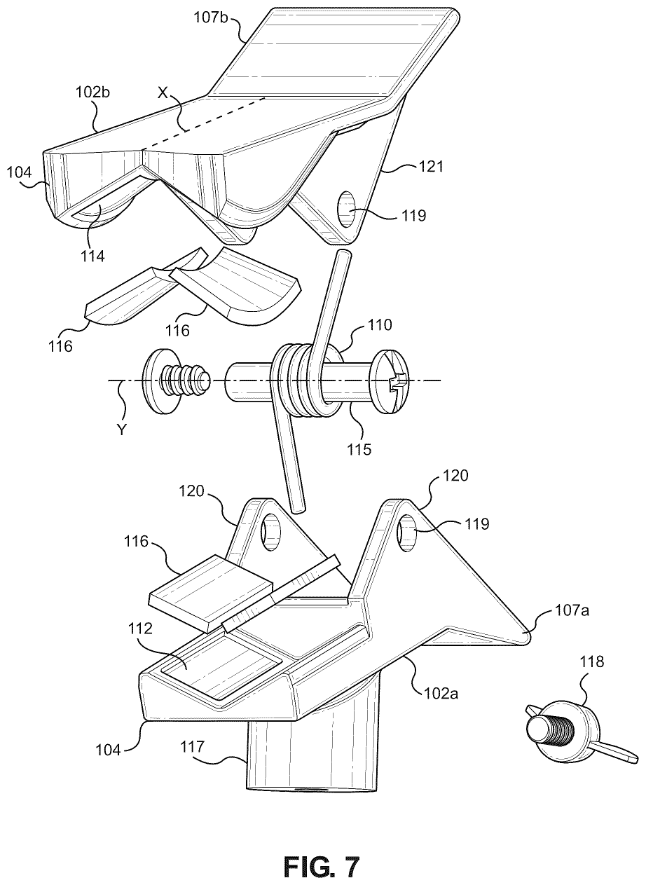

FIG. 3 shows a perspective view of vial receiving portion 101 having longitudinal axis X along the upper surface of vial engaging member 102a, wherein longitudinal axis X is taken with vial receiving portion 101 in an open configuration such that the upper surface of vial engaging member 102a and the bottom surface of vial engaging member 102b are parallel to one another. FIG. 3 further shows first vial engaging member 102a rotatably coupled to second vial engaging member 102b by hinge 103. As explained in further detail under FIGS. 6 and 7, vial engaging member 102a and second vial engaging member 102b can each have a pair of opposing hinge openings 119 for permitting one or more connecting means to rotatably connect the vial engaging members to one another to form hinge 103. The connecting means of hinge 103 has longitudinal axis Y about which first vial engaging member 102a and second vial engaging member 102b rotate. Hinge 103 can comprise any connection means that permits the vial engaging members to be rotatably coupled to one another. Suitable connection means for hinge 103 include, but are not necessarily limited to, screws, screw posts, bolts, pins, and shafts. In the embodiment depicted in the figures, the connection means of hinge 103 is a screw post. In some embodiments, the connection means for hinge 103 comprises a shaft having an enlarged head on one end, and a retaining portion on the opposing end, wherein the retaining portion is a hole for receiving a cotter pin or indentation that is adapted to receive a retaining ring, for example.

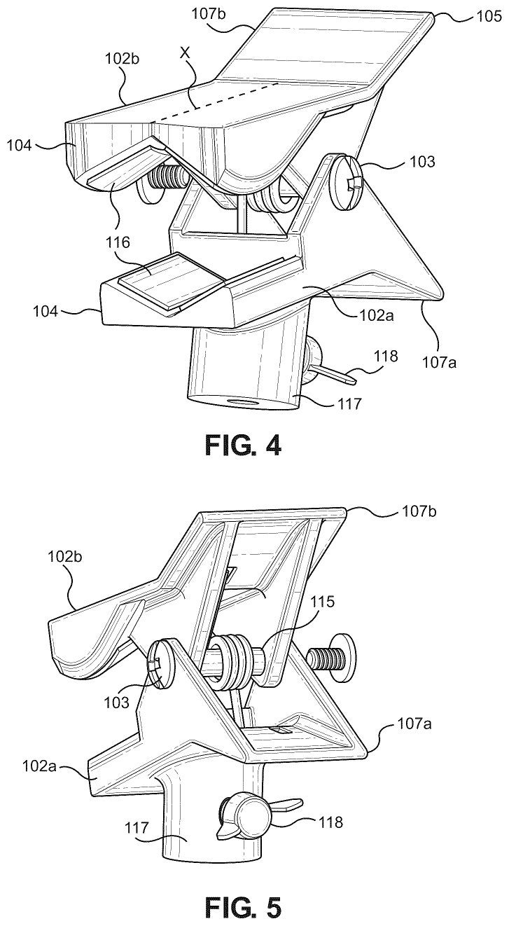

FIGS. 3-7 show an embodiment of the invention wherein the connection means traverses spring 110 to secure the spring within vial receiving portion 101 to permit tension from spring 110 to force first vial engaging member 102a towards second vial engaging member 102b on forward end 104 of vial receiving portion 101. FIGS. 3-5 show vial receiving portion 101 in an open configuration for receiving a vial, wherein spring 110 is compressed and first vial engaging member 102a and second vial engaging member 102b are separated from one another on forward end 104.

Still referring to FIGS. 3-7, spring 110 is traversed by the connection means of hinge 103 in vial receiving portions 101's assembled state. In vial receiving portions 101's assembled state, the ends of spring 110 contact the inner surfaces of ears 107a and 107b of first vial engaging member 102a and second vial engaging member 102b such that spring 110 is permitted to force first vial engaging member 102a towards second vial engaging member 102b on forward end 104. In the embodiments shown in FIGS. 3-7, connection means 115 for hinge 103 comprises a screw post.

FIGS. 6 and 7 show an exploded view of an embodiment of vial receiving portion 101 wherein first vial engaging member 102a comprises first surface 111 and second surface 112, and second vial engaging member 102b comprises third surface 113 and fourth surface 114. First surface 111 and second surface 112 can oppose one another, and third surface 113 and fourth surface 114 can oppose one another, at a right angle, an obtuse angle or an acute angle, wherein the vertices of the angles are formed by longitudinal axes that are parallel to longitudinal axis X. In preferred embodiments, first surface 111 opposes second surface 112, and third surface 113 opposes fourth surface 114, at an obtuse angle along vertices that are parallel to longitudinal axis X. One or more of the surfaces can be curved, such that the convex portion of the one or more surfaces faces inward towards the opposing vial engaging member. Third surface 113 and fourth surface 114 can have the shape of a portion of a conical frustum. In some preferred embodiments, first surface 111 and second surface 112 are flat, while third surface 113 and fourth surface 114 are curved. In such an arrangement, first vial engaging member 102a and second vial engaging member 102b are permitted to hold vials (or other containers having a circular cross-section) of various sizes in a stable orientation under the force of spring 110. In some preferred embodiments, first vial engaging member 102a forms the bottom, and second vial engaging member 102b forms the top, of vial receiving portion 101, such as shown in the embodiment of FIG. 2. In such embodiments, first surface 111 and second surface 112 form a ramp for stably receiving the side of a vial having a circular cross section when vial receiving portion 101 assumes an open configuration through a user's compression of ears 107a and 107b. With the vial so installed, the grip of the user is relaxed so that curved third and fourth surfaces 113 and 114 come into contact with the opposing side of the vial thereby securing the vial between first vial engaging member 102a and second vial engaging member 102b under the force of spring 103.

One or more of first surface 111, second surface 112, third surface 113, and fourth surface 114, can each have thereon friction member 116. Friction member 116 can cover at least a portion of the surfaces. Friction member 116 is made from a material sufficient to increase the coefficient of friction between friction member 116 and a vial or other container held within vial receiving portion 101, wherein the vial or other container is made from material selected from, for example, glass or plastic. Suitable materials for friction member 116 include, but are not necessarily limited to, rubber, silicone, latex, a thermoplastic vulcanizate (e.g., Santoprene™) or combinations thereof. In some embodiments, at least one of first surface 111, second surface 112, third surface 113 and fourth surface 114 comprise depressions that are adapted to nest with their corresponding friction member 116.

FIGS. 6 and 7 show an exploded view of vial receiving portion 101, wherein first vial engaging member 102a includes first hinge portions 120 and second vial engaging member 102b includes second hinge portions 121, each of first hinge portions 120 and second hinge portions 121 having hinge openings 119. In vial receiving portion 101's assembled state, first hinge portions 120 straddle second hinge portions 121 such that hinge portions 120 form the outside sidewalls of vial receiving portion 101. In vial receiving portion 101's assembled state, hinge openings 119 of first hinge portions 120 align with hinge openings 119 of hinge portions 121 to permit connection means 115 to traverse first hinge portions 120, second hinge portions 121 and spring 110 to maintain vial receiving portion 101 in an assembled state.

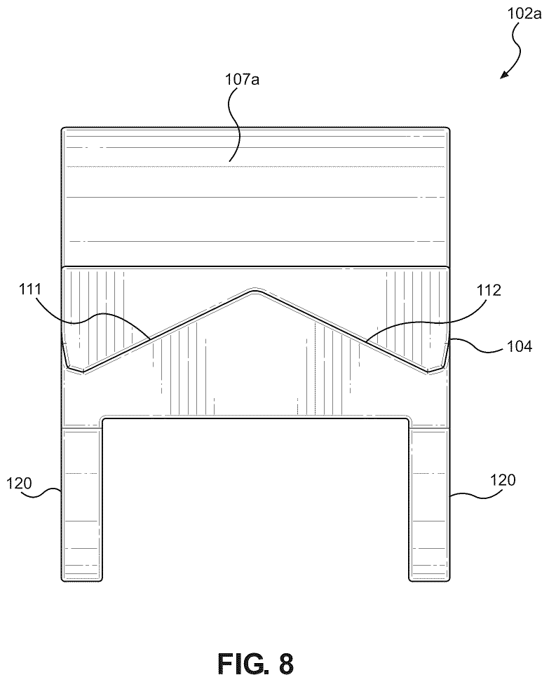

FIG. 8 is a front view of forward end 104 of first vial engaging member 102a showing first surface 111, second surface 112, ear 107a and first hinge portions 120. As shown in FIG. 8, first surface 111 meets second surface 112 such that the surfaces oppose one another at an obtuse angle. In some preferred embodiments, first surface 111 meets second surface 112 at an angle of about 128 degrees. As shown in FIG. 8, first surface 111 can meet second surface 112 to form a vertex. However, it will be appreciated that first surface 111 can meet second surface 112 such that the surfaces are joined by an elliptical or semi-circular portion. It will further be appreciated that first surface 111 and second surface 112 may not join at a vertex, but can instead be separated by a gap, or assume any shape or configuration at their joining surfaces, without departing from the spirit of the invention.

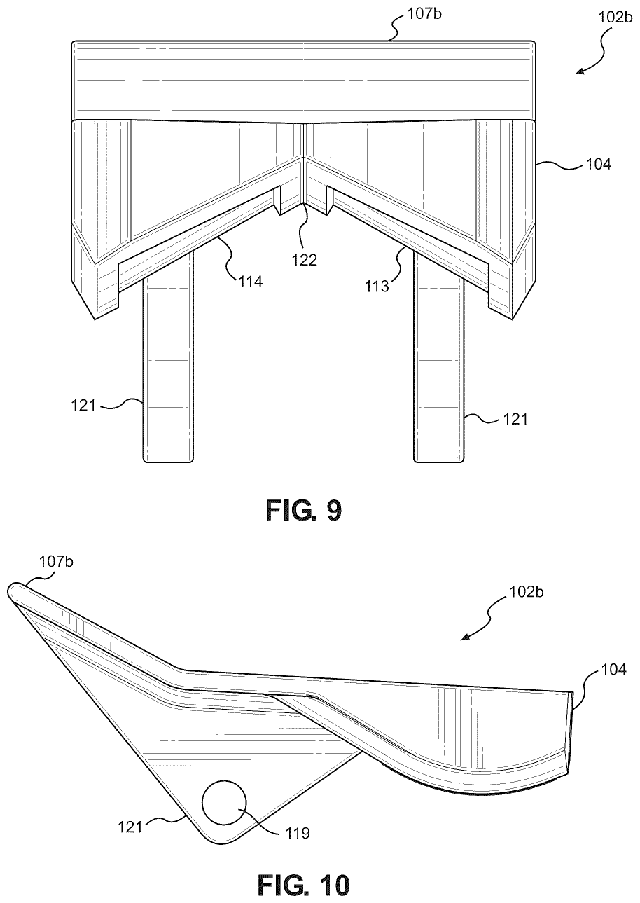

FIG. 9 is a front view of forward end 104 of second vial engaging member 102b showing third surface 113, fourth surface 114, ear 107b and second hinge portions 121. Vial engaging member 102b can include ridge 122 which separates third surface 113 from fourth surface 114. Ridge 122 can form arced surfaces parallel to longitudinal axis X, wherein the arced have the same profile as the arced end surfaces of third surface 113 and fourth surface 114. In embodiments where second vial engaging member 102b incorporates friction members 116, ridge 122 separates the friction members. As shown in FIG. 9, the arcs of third surface 113 and fourth surface 114 oppose one another at an obtuse angle. In some embodiments, third surface 113 opposes fourth surface 114 at an angle of about 128 degrees. FIG. 10 shows a left side view of second vial engaging member 102b including forward end 104, ear 107b, hinge opening 119 and second hinge portion 121.

In some aspects, the invention provides a method of holding a vial or other container for hands-free access to the vial or other container, such as for purposes of aspiration by a syringe. The method can be practiced by providing the apparatus disclosed herein, and securing the apparatus to a surface such as a surgical tray, counter, or patient bedside. A user then presses ears 107a and 107b towards one another to compress spring 110 thereby separating first vial engaging member 102a from second vial engaging member 102b on forward end 104 thereby placing the apparatus in an open configuration. The vial receiving portion is then loaded with a vial or other container such that the lateral side of the vial or other container is placed lengthwise against first surface 111 and second surface 112. The user then relaxes their grip on ears 107a and 107b to permit the vial the engaging members to advance towards one another under the force of spring 110 to place vial receiving portion 101 in a closed configuration such that surfaces 111, 112, 113 and 114 press against the sides of the vial or other container under tension of spring 110 thereby holding and stabilizing the vial or other container. The vial or other container is then ready for hands-free access, such as for aspiration by a syringe.

1. An apparatus for holding a vial, comprising:
a) a vial receiving portion comprising a first vial engaging member rotatably connected to a second vial engaging member by a hinge;
b) a stand coupled to the vial receiving portion, wherein the stand is adapted to be secured to a surface.

2. The apparatus of claim 1, wherein the vial receiving portion is adapted to receive a bottom of a vial.

3. The apparatus of claim 1, wherein the first vial engaging member includes a first surface and a second surface, and the second vial engaging member includes a third surface and a fourth surface.

4. The apparatus of claim 3, wherein the first surface and second surface oppose one another at an acute angle, an obtuse angle, or a 90-degree angle.

5. The apparatus of claim 3, wherein the third surface and the fourth surface oppose one another at an acute angle, an obtuse angle, or a 90-degree angle.

6. The apparatus of claim 3, wherein the first surface and the second surface are flat.

7. The apparatus of claim 3, wherein the third surface and the fourth surface are curved.

8. The apparatus of claim 3, wherein each of the surfaces are curved.

9. The apparatus of claim 3, wherein each of the surfaces are flat.

10. The apparatus of claim 3, wherein the (i) third surface and the fourth surface are convex and face the first surface and the second surface, and (ii) the first surface and the second surface are flat.

11. The apparatus of claim 3, wherein at least one of the surfaces includes a friction member that is adapted to produce friction against a surface of a vial.

12. The apparatus of claim 11, wherein the friction member is made of rubber, silicone, latex, a thermoplastic vulcanizate, or combinations thereof.

13. The apparatus of claim 3, wherein (i) the first surface and the second surface meet along a first axis, (ii) the third surface and the fourth surface meet along a second axis, (iii) the hinge has a longitudinal axis, and (iv) the first axis and the second axis are parallel to the longitudinal axis of the hinge.

14. The apparatus of claim 1, wherein (i) the vial receiving portion has a forward end and a rear end, (ii) the stand has an upper end and a lower end, (iii) the vial receiving portion is coupled to the upper end of the stand, and (iv) the forward end of the vial receiving portion is biased towards the lower end of the stand.

15. The apparatus of claim 14, wherein the forward end of the vial receiving portion is biased towards the lower end of the stand at an angle of up to about 45 degrees as determined by a horizontal plane that is perpendicular to a longitudinal axis of the stand.

16. The apparatus of claim 1, wherein the vial receiving portion is rotatably coupled to the stand.

17. The apparatus of claim 1, wherein the first vial engaging member and the second vial engaging member are in mechanical communication with a spring that is adapted to force the first vial engaging member toward the second vial engaging member.

18. The apparatus of claim 17, wherein (i) the vial receiving portion has a forward end and a rear end, and (ii) the spring is adapted to force the first vial engaging member toward the second vial engaging member on the forward end of the vial receiving portion.

19. The apparatus of claim 18, wherein (i) the first vial engaging member and the second vial engaging member form a pair of ears on the rear end of the vial receiving portion, and (ii) the ears are adapted to be compressed towards one another thereby compressing the spring and separating the first vial engaging member from the second vial engaging member on the forward end of the vial receiving portion.

20. An apparatus for holding a vial, comprising:
a) a first vial engaging member having a pair of opposing planar surfaces arranged at a first angle with respect to one another;
b) a second vial engaging member rotatably connected to the first vial engaging member, the second vial engaging member having a pair of opposing curved surfaces arranged at a second angle with respect to one another;
c) a spring in mechanical communication with the first vial engaging member and the second vial engaging member, wherein the spring is adapted to force the first vial engaging member toward the second vial engaging member;
d) a longitudinal stand coupled to a bottom of the second vial engaging member on a first end of the longitudinal stand; and
e) a stand securing member coupled a second end of the longitudinal stand, wherein the stand securing member is adapted to secure the stand to a surface.
